(19) United States
(12) Patent Application Publication
(10) Pub. No.: US 2025/0230076 A1
(43) Pub. Date: Jul. 17, 2025

(54) METHOD FOR BLENDING FRAGRANCE AND DYE COMPOUNDS WITH OXIDIZING AGENTS FOR USE IN SWIMMING POOLS AND SPAS

(71) Applicant: Oxygen Pools, LLC d/b/a Oxygen Water Products, Palm Beach Gardens, FL (US)

(72) Inventors: Richard Holstein, Palm Beach Gardens, FL (US); Daniel Holstein, Langhorne, PA (US)

(21) Appl. No.: 19/016,585

(22) Filed: Jan. 10, 2025

Related U.S. Application Data
(60) Provisional application No. 63/620,389, filed on Jan. 12, 2024.

(51) Int. Cl. C02F 1/68; C02F 1/72; C02F 103/42

(52) U.S. Cl. CPC C02F 1/68; C02F 1/72; C02F 2103/42; C02F 2305/02

(57) ABSTRACT

Method for manufacturing a fragrance infused oxidizing agent used in swimming pools and spas. The infused oxidizing agent manufactured includes an oxidizing compound, a fragrance, an absorbent carrier, and optionally, a dye.

In accordance with 37 C.F.R. 1.76, a claim of priority is included in an Application Data Sheet filed concurrently herewith. The present invention claims priority to U.S. Provisional Application No. 63/620,389, entitled “METHOD FOR BLENDING FRAGRANCE AND DYE COMPOUNDS WITH OXIDIZING COMPOUNDS FOR USE IN SWIMMING POOLS AND SPAS”, filed on Jan. 12, 2024. The contents of the above referenced application are incorporated herein by reference in their entirety.

### FIELD OF THE INVENTION

The present invention relates to methods of making chemical compositions for use in recreational waters; and more particularly, to methods for manufacturing fragrance infused oxidizing agent(s) for use in swimming pools and spas.

### BACKGROUND OF THE INVENTION

The use of oxidizers in recreational water, such as swimming pools and spas, is necessary for reduction of bacteria, viruses and algae in the water. These oxidizers are used to 1) create a residual sanitizer level, or 2) used as a shocking agent to oxidize excess contaminants beyond the capacity of a residual sanitizer level.

While the use of oxidizers is necessary for maintaining a healthy pool or spa, oxidizers create unhealthy and unpleasant side effects for bathers. These come in the form of combined chlorine molecules that are a natural part of their oxidation process. Two by-products of the oxidation process include trihalomethane, a well-known respiratory irritant, and ammonia, which affects eyes and skin, manifesting as red, irritated eyes, dry skin, and skin rashes.

These unhealthy and unpleasant effects are experienced by bathers and those in the vicinity as “chlorine” odor. It is common for recreational water users to experience the strong odor of chlorine upon entering a building with an indoor pool or spa. The strong order is the result of the formation of combined chlorine and is, unfortunately, the desired result of the oxidation process of the sanitizers used in the water.

There has existed an inherent need by owners of pools and spas to minimize chlorine odors for bather comfort and the safety of bathers and to avoid inhalation of, and immersion in, trihalomethanes and other ammonia based by-products of the pool/spa sanitation process. This is evidenced by the popularity of scented salts used to mask sanitizer odors in pools and spas, whose popularity has grown continuously for decades. The shortfall of fragrance infused salts crystals has been the superficial masking of these harmful compounds without eliminating them from the water. For that function, an oxidizing agent is required.

While the use of oxidizers for cleaning and sanitizing water is well known, the difficulty of safely preparing, blending and packaging oxidizers with any other components is well known among those skilled in the handling of these materials. As such, systems and methods to safely manufacture a stable, free fragrance infused oxidizing agent(s) are required.

### SUMMARY OF THE INVENTION

In certain embodiments, methods for manufacturing fragrance infused oxidizing agent(s) for use in swimming pools and spas are provided. The method of manufacturing a fragrance infused oxidizing agent(s) results in a composition that includes an oxidizing agent, a fragrance, an absorbent, and, optionally, a dye.

Embodiments of the process described herein comprise a method developed exclusively by the inventors to safely mix, blend and package certain oxidizers with fragrances and/or dyes that will reduce odors by shocking the water, thereby reducing ammonia based contaminates. In addition, the end product developed by the process results in a body of water that has a pleasant, aromatherapy experience for bathers and those in the vicinity of the reservoir. The end product that results from the process remains fully functional. That is, addition of oxidizers with fragrances using the methods described herein does not interfere with or reduce the sanitation process or coat of filter media or surfaces by the addition of the fragrances or dyes.

Accordingly, it is an objective of the invention to provide methods for manufacturing a fragrance infused oxidizing agent(s) for use in swimming pools and spas.

It is a further objective of the invention to provide a method of manufacturing a fragrance infused oxidizing agent(s) comprising an oxidizing agent, a fragrance and an absorbent.

It is yet another objective of the invention to provide a method of manufacturing a fragrance infused oxidizing agent(s) comprising an oxidizing agent, a fragrance, an absorbent, and a dye.

It is a further objective of the invention to provide a method of manufacturing a fragrance infused oxidizing agent(s) comprising an oxidizing agent and a fragrance.

It is yet another objective of the invention to provide a method of manufacturing a fragrance infused oxidizing agent(s) comprising an oxidizing agent, a fragrance, and a dye.

It is a still further objective of the invention to provide oxidizers with fragrances that do not interfere with or reduce the sanitation process.

It is a further objective of the invention to provide oxidizers with fragrances and dyes that do not coat filter media or surfaces of the reservoir.

It is yet another objective of the invention to provide systems having one or more apparatus or devices for use in the manufacturing process of making a fragrance infused oxidizing agent(s) for use in swimming pools and spas.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1 is a schematic diagram illustrating a system for use in the process of manufacturing a fragrance infused oxidizing agent(s) used in swimming pools and spas in accordance with the present invention;

FIG. 2 provides an illustrative embodiment of a method of manufacturing fragrance infused oxidizing agent(s) for use in swimming pools and spas in accordance with the present invention, and

FIG. 3 provides an alternative embodiment of a method of manufacturing fragrance infused oxidizing agent(s) for use in swimming pools and spas in accordance with the present invention.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

Embodiments of methods of making chemical compositions for use in recreational waters, and more particularly, systems and methods for manufacturing fragrance infused oxidizing agent(s) for use in swimming pools and spas are provided. The methods for manufacturing fragrance infused oxidizing agent(s) include equipment, composition of components, and the sequential loading, drying, mixing and blending of components within a specific range of environmental and atmospheric parameters to safely manufacture a stable, free flowing end product, i.e., the fragrance infused oxidizing agent. The stable, free flowing end product includes an oxidizing agent, a fragrance, an absorbent, and optionally, a dye, see Tables 1-6.

As used herein, the term “oxidizing agent” (may also be referred to as an “oxidizer”) is defined as a substance that has the ability to oxidize other substances, i.e., cause them to lose electrons. Illustrative embodiments of an oxidizing agent include an oxidizing compound consisting of either potassium peroxymonopersulfate (PMP) or dichloro-isocyanurate (dichlor). The oxidizing agent may comprise between 60-90% of total composition.

As used herein, the term “fragrance” may include any substance that provides or conveys a smell or scent. The fragrance may be a natural fragrance (made from or of one or more natural ingredients) or a man-made, artificial (made from or of one or more chemicals/aroma chemicals) fragrance. In certain embodiments, the fragrance may be a liquid fragrance composition having a specific gravity less than 2.975 g/cm. The fragrance may convey a single scent or a combination of scents. The fragrance may comprise between 0.5-5% of the total composition.

As used herein, an “absorbent” may include an anhydrous absorbent carrier acting as a drying catalyst. In certain embodiments, the absorbent may include any of the following compounds in anhydrous condition: sodium bicarbonate, sodium carbonate, or sodium sesquicarbonate. The absorbent may comprise between 5-30% of the total composition.

As used herein, “dye” includes a natural or synthetic staining or coloring substance. In certain embodiments, the dye may include a powdered dye composition having a specific gravity less than 3.75 g/cm. The dye may comprise between 0.5-5% of the total composition.

As used herein, any numerical value could also be defined using the term “about”. As used herein, term “about” includes any value greater than 0% and less than 10%, higher or lower, than the stated value. For exempla if a value is stated as being 50%, such value could include the term about 50%.

TABLE 1
Product No. 1

| | Concentration |
|---|---|
| Composition | (% of total composition) |
| oxidizing agent | 65-90% |
| fragrance | 0.5-5% |
| absorbent | 5-30% |

TABLE 2
Example Product No. 2

| | Concentration |
|---|---|
| Composition | (% of total composition) |
| oxidizing agent | 60-90% |
| fragrance | 0.5-5% |
| absorbent | 5-30% |
| dye | 0.5-5% |

TABLE 3
Example Product No. 3

| | Concentration |
|---|---|
| Composition | (% of total composition) |
| oxidizing agent: potassium | 65-90% |
| peroxymonopersulfate (PMP) or | |
| dichloro-isocyanurate (dichlor) | |
| fragrance | 0.5-5% |
| absorbent | 5-30% |

TABLE 4
Example Product No. 4

| | Concentration |
|---|---|
| Composition | (% of total composition) |
| oxidizing agent: potassium | 60-90% |
| peroxymonopersulfate (PMP) or | |
| dichloro-isocyanurate (dichlor) | |
| fragrance | 0.5-5% |
| absorbent | 5-30% |
| dye | 0.5-5% |

TABLE 5
Example Product No. 5

| | Concentration |
|---|---|
| Composition | (% of total composition) |
| oxidizing agent: potassium | 65-90% |
| peroxymonopersulfate (PMP) or | |
| dichloro-isocyanurate (dichlor) | |
| fragrance | 0.5-5% |
| absorbent: sodium bicarbonate, | 5-30% |
| sodium carbonate, or | |
| sodium sesquicarbonate | |

TABLE 6
Example Product No. 6

| | Concentration |
|---|---|
| Composition | (% of total composition) |
| oxidizing agent: potassium | 60-90% |
| peroxymonopersulfate (PMP) or | |
| dichloro-isocyanurate (dichlor) | |
| fragrance | 0.5-5% |
| absorbent: sodium bicarbonate, | 5-30% |
| sodium carbonate, or | |
| sodium sesquicarbonate | |
| dye | 0.5-5% |

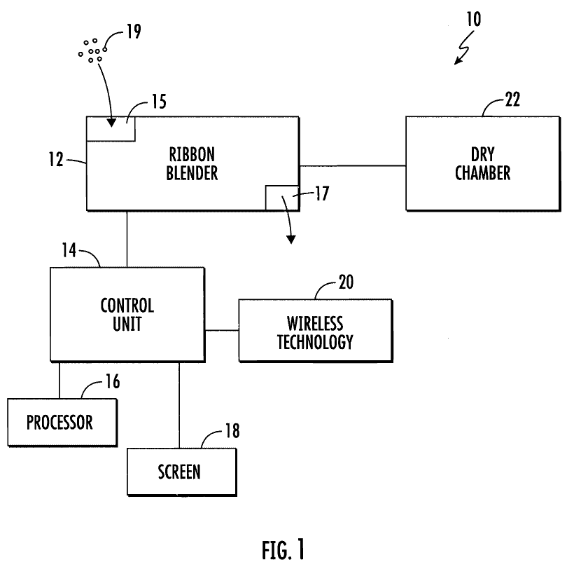

Referring to FIG. 1, a schematic diagram illustrating a system of one or more apparatus or machines used in manufacturing a fragrance infused oxidizing agent(s) used in swimming pools and spas, referred to generally as system for manufacturing a fragrance infused oxidizing agent 10, is illustrated. The system for manufacturing a fragrance infused oxidizing agent 10 may include a blending apparatus 12, such as a ribbon blender or a paddle blender. The ribbon or paddle blender 12 may be a minimum 316 finish stainless steel blending apparatus with counter directional rotation capability, with, for example, 100 cubic feet, or larger, capacity. The blender 12 may include an inlet 15 and outlet 17 for inserting material(s) 19 to be blended or removing material(s) 19 already blended. A control unit 14 (which may include a processor 16, and other necessary hardware or software, and a screen 18 [such as an LED screen, with or without touch screen capability]) may be used to control the blender 12. The control unit 14 may be operational via wireless technology 20 (receivers/transmitters, software applications). As such, the control unit 14 may provide remote electronic variable speed control providing incremental blending speeds to accommodate the varying degrees of resistance of specific oxidizers and the specific gravity of fragrances used in the process.

The system for manufacturing a fragrance infused oxidizing agent 10 may also include one or more drying chambers 22. Use of a dedicated drying chamber 22 allows the process of manufacturing the fragrance infused oxidizing agent to attain a specific maximum moisture content of the oxidizer(s) prior to blending. In certain embodiments, the drying chamber 22 may include an enclosed structure, such as but not limited to an approximately 12 feet by 12 feet, square, with a height sufficient to provide access for a standard forklift for insertion and removal of up to pallet sized payloads for drying. The drying chamber 22 preferably has a dehumidifying capacity sufficient to attain humidity levels of less than 40% humidity inside the chamber, 25% hourly turnover of cubic foot interior air capacity and with fresh air return of no more than 10% of cubic foot interior air capacity. Maximum temperature inside the drying chamber 22 is less than 80 degrees F.

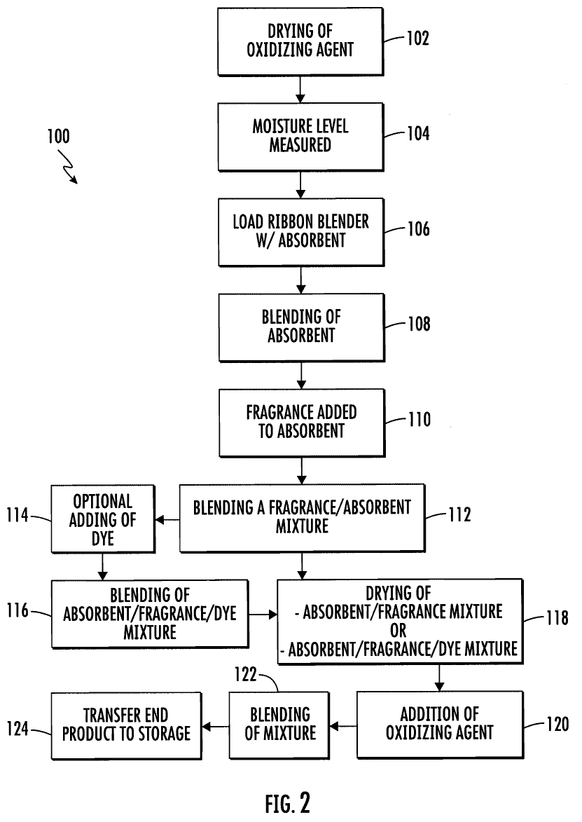

Referring to FIG. 2, an illustrative example of a method for manufacturing a fragrance infused oxidizing agent(s) used in swimming pools and spas, referred to generally as a method for manufacturing a fragrance infused oxidizing agent 100, is illustrated.

The entire manufacturing process is completed in a climate controlled environment of between 65-80 degrees F. and a humidity level of less than 60% to insure desired drying and blending levels are achieved. The steps in manufacturing the fragrance infused oxidizing agent include the following:
Step 1: Prior to blending, an oxidizer, such as bulk oxidizer in 50 lb. or 50 kg bags or metric ton sacks, is placed inside a drying chamber (such as drying chamber 22) until the moisture content of the oxidizer is under 0.5% at temperatures less than 80 degrees Fahrenheit (° F.), see 102. Moisture levels of the oxidizer is measured or confirmed, see 104, using an AquaLab3 total moisture content analyzer (AquaLab, Pullman, WA) prior to initiating the blending process. Alternatively, the oxidizer may be placed in the dryer for a time period until it reaches the manufacturer's determined maximum moisture content for that oxidizer used.
Step 2: An anhydrous absorbent is loaded into a blender, such as the ribbon or paddle blender 12, see 106, and blended, 108, for up to 10 minutes to spread evenly so the anhydrous absorbent is equally distributed throughout the blender.
Step 3: A fragrance, such as a liquid fragrance, is added to the anhydrous absorbent, see 110, and blended for up to 10-20 minutes, relative to the specific gravity of the fragrance, see 112.
Step 4: Optionally, a dye, such as a powdered dye, is added to the absorbent/fragrance mixture, see 114, and blended for up to 10-20 minutes, see 116.
Step 5: The blended mixture of an anhydrous absorbent and a liquid fragrance or the blended mixture of an anhydrous absorbent, a liquid fragrance and a dye is allowed to dry, up to three hours, in the blender, see 118, mixing occasionally to assure uniform drying to a maximum moisture content of 0.5%, as measured by comparable equipment as described in Step 1 above before adding the oxidizer into the blender.
Step 6: An oxidizer, in a specified amount, is added to the anhydrous absorbent/liquid fragrance mixture or the anhydrous absorbent/liquid fragrance/dye mixture, see 120. After loading the oxidizer, the blending process is initiated at a slowest incremental rotational speed and slowly increased over a 2-minute period to no more than 10 rotations per minute. Once maximum rotations are attained, the blending continues for up to 10 minutes in each direction, clockwise and counterclockwise, see 122.
Step 7: Once fully mixed, the fully blended mixture is immediately transferred to packaging bins for storage or transfer into retail containers, see 122. Bulk or retail container storage may be maintained for a minimum of 7 days to assure stability of the mixture.

The final blended composition (a fragrance infused oxidizing agent comprising an oxidizer, a fragrance, an anhydrous absorbent or a fragrance infused oxidizing agent comprising an oxidizer, a fragrance, an anhydrous absorbent, and a dye) may be used by introducing the composition into a swimming pool or into a spa.

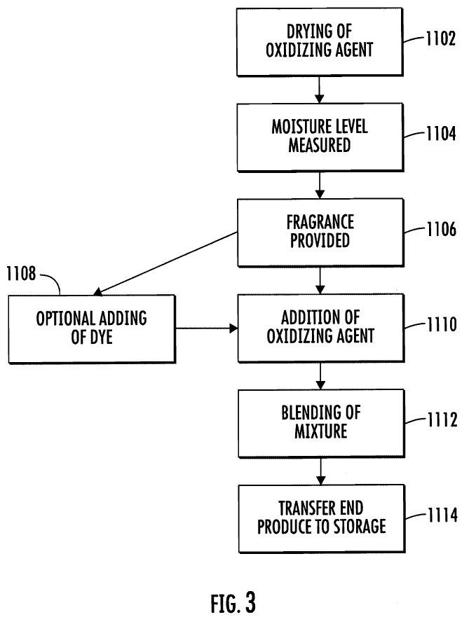

FIG. 3 illustrates an alternative method of manufacturing a fragrance infused oxidizing agent(s) for use in swimming pools and spas. The method described in FIG. 3 utilizes many of the same steps or procedural methods as described above, but does not include the use of an absorbent. Briefly, an oxidizer is dried as described above, see step 1102. Moisture levels of the oxidizer are measured or confirmed as described previously, see step 1104. A fragrance is provided, see step 1106. Optionally, a dye may be used, see step 1108. The oxidizer is added to the fragrance or fragrance and dye, see step 1110. The mixture may be blended as described previously, see step 1112. The end product can then be transferred to storage, as described previously, see 1114.

Tables 7-10 provide the end product without an absorbent: fragrance infused oxidizing agent comprising an oxidizer and a fragrance or a fragrance infused oxidizing agent comprising an oxidizer, a fragrance, and a dye.

TABLE 7
Product No. 7

| | Concentration |
|---|---|
| Composition | (% of total composition) |
| oxidizing agent | 95-99.5% |
| fragrance | 0.5-5% |

TABLE 8
Example Product No. 8

| | Concentration |
|---|---|
| Composition | (% of total composition) |
| oxidizing agent | 90-99% |
| fragrance | 0.5-5% |
| dye | 0.5-5% |

TABLE 9
Example Product No. 9

| | Concentration |
|---|---|
| Composition | (% of total composition) |
| oxidizing agent: potassium | 95-99.5% |
| peroxymonopersulfate (PMP) or | |
| dichloro-isocyanurate (dichlor) | |
| fragrance | 0.5-5% |

TABLE 10
Example Product No. 10

| | Concentration |
|---|---|
| Composition | (% of total composition) |
| oxidizing agent: potassium | 90-99% |
| peroxymonopersulfate (PMP) or | |
| dichloro-isocyanurate (dichlor) | |
| fragrance | 0.5-5% |
| dye | 0.5-5% |

The final blended composition (a fragrance infused oxidizing agent comprising an oxidizer and a fragrance or a fragrance infused oxidizing agent comprising an oxidizer, a fragrance, and a dye) may be used by introducing the composition into a swimming pool or into a spa.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method of manufacturing fragrance infused oxidizing agent for use in swimming pools and spas comprising:
using climate controlled environment,
drying an oxidizer;
blending an anhydrous absorbent;
adding a fragrance to said blended anhydrous absorbent;
optionally adding a dye to said fragrance-blended anhydrous absorbent mixture;
adding said oxidizer to said fragrance-blended absorbent mixture or to said fragrance-blended anhydrous anhydrous absorbent-dye mixture;
forming a fragrance infused oxidizing agent comprising an oxidizer, a fragrance, an anhydrous absorbent or a fragrance infused oxidizing agent comprising an oxidizer, a fragrance, an anhydrous absorbent, and a dye by blending said oxidizer with said fragrance-anhydrous absorbent mixture or with said fragrance-anhydrous absorbent-dye mixture.

2. The method according to claim 1, wherein said climate controlled environment is between about 65 degrees F. and about 80 degrees F.

3. The method according to claim 1, wherein said climate controlled environment includes a humidity level of less than 60%.

4. The method according to claim 1, wherein said fragrance is natural fragrance.

5. The method according to claim 1, wherein said fragrance is artificial fragrance.

6. The method according to claim 1, wherein said fragrance is a liquid fragrance.

7. The method according to claim 6, wherein said liquid fragrance is a composition having a specific gravity of less than 2.975 g/cm.

8. The method according to claim 1, wherein said fragrance may convey a single scent or a combination of scents.

9. The method according to claim 1, wherein said absorbent is sodium bicarbonate, sodium carbonate, or sodium sesquicarbonate.

10. The method according to claim 1, wherein said dye is a natural or synthetic staining or coloring agent.

11. The method according to claim 1, wherein said oxidizing agent includes potassium peroxymonopersulfate (PMP).

12. The method according to claim 1, wherein said oxidizing agent includes dichloro-isocyanurate (dichlor).

13. The method according to claim 1, wherein said moisture levels of the oxidizer is measured prior to initiating said blending process.

14. A method of manufacturing fragrance infused oxidizing agent(s) comprising:
in a climate, controlled environment where the temperature is between about 65 degrees Fahrenheit and about 80 degrees Fahrenheit and a humidity level of less than 60%;
placing an oxidizing agent within a drying chamber for a sufficient time period to reach said oxidizing agent's manufacturer's determined maximum moisture content at temperatures less than 80 degrees Fahrenheit;
placing an anhydrous absorbent in a bleeding device for a period of time to distribute said anhydrous absorbent within said blending device;
adding a fragrance(s) to said anhydrous absorbent;
blending said fragrance(s) and said anhydrous absorbent to form a blended fragrance-anhydrous absorbent mixture;
optionally, adding a dye to said fragrance(s) and said anhydrous absorbent;
blending said dye, said fragrance(s) and said anhydrous absorbent to form a blended dye-fragrance-anhydrous absorbent mixture;
drying said blended fragrance-anhydrous absorbent mixture or said blended dye-fragrance-anhydrous absorbent mixture for a period of up to about 3 hours, mixing occasionally to assure uniform drying to a maximum moisture content of 0.5%; and
blending said oxidizing agent to said blended fragrance-anhydrous absorbent or mixture said blended dye-fragrance-anhydrous absorbent mixture, thereby forming a fragrance infused oxidizing agent comprising an oxidizing agent, a fragrance(s), an anhydrous absorbent or a fragrance infused oxidizing agent comprising an oxidizing agent, a fragrance(s), an anhydrous absorbent, and a dye.

15. The method according to claim 14, wherein,
said oxidizing agent is at concentration of about 60%-90%;
said fragrance(s) is at concentration of about 0.5%-5%;
said fragrance(s) is at concentration of about 58-30%; and
if said dye is provided, said dye is at concentration of about 0.5%-5%.

16. The method according to claim 14, wherein said oxidizing agent includes potassium peroxymonopersulfate (PMP).

17. The method according to claim 14, wherein said oxidizing agent includes dichloro-isocyanurate (dichlor).

18. The method according to claim 14, wherein said absorbent is sodium bicarbonate, sodium carbonate, or sodium sesquicarbonate.
